(19) United States
(12) Patent Application Publication
(10) Pub. No.: US 2011/0154176 A1
(43) Pub. Date: Jun. 23, 2011

(54) ELECTRONIC DOCUMENT MANAGING APPARATUS AND COMPUTER-READABLE RECORDING MEDIUM

(75) Inventors: Kazuo INUI, Itami-shi (JP); Nobuhiro MISHIMA, Osaka-shi (JP); Hidetaka IWAI, Itami-shi (JP); Kaitaku OZAWA, Itami-shi (JP)

(73) Assignee: Konica Minolta Business Technologies, Inc., Chiyoda-ku (JP)

(21) Appl. No.: 12/967,545

(22) Filed: Dec. 14, 2010

(30) Foreign Application Priority Data
Dec. 18, 2009 (JP) 2009-287520

(51) Int. Cl. G06F 17/00

(52) U.S. Cl. 715/205

(57) ABSTRACT

An electronic document managing apparatus includes a link information acquiring unit, an integration unit, and an addition unit. The link information acquiring unit acquires link information relating to link destinations inside each of a plurality of electronic documents. The integration unit integrates the respective pieces of link information relating to the plurality of electronic documents to generate integrated link information. The addition unit adds the integrated link information to the plurality of electronic documents, respectively.

This application is based on Japanese Patent Application No. 2009-287520 filed on Dec. 18, 2009, the contents of which are hereby incorporated by reference.

### BACKGROUND OF THE INVENTION

1. Field of the Invention

The present invention relates to an electronic document managing apparatus and a technique relating to the same, and particularly to a technique that facilitates mutual reference between a plurality of electronic documents.

2. Description of the Background Art

There exists a technique of referring to, and displaying (jumping and displaying) a specific portion in an electronic document easily.

For example, in Japanese Patent Application Laid-Open No. 2007-72577, there has been described an electronic booklet display system that displays an electronic booklet having a plurality of pages. In this electronic booklet display system, landmark information for a specific page of the electronic booklet is first attached by operation input of a user. Based on the landmark information, contents of the specific page corresponding to the landmark information are displayed.

Moreover, in an electronic document such as a portable document format (PDF) document, there is a technique of clicking on a bookmark item to thereby jump to a page of interest. Specifically, selection operation is performed to select a desired bookmark item from a plurality of bookmark items (also referred to as table-of-contents items) displayed in a bookmark display field in the PDF document. In response to the selection operation, a page of a link destination associated with the desired bookmark item is displayed on a body text display field of the PDF document.

However, since the technique described in Japanese Patent Application Laid-Open No. 2007-72577 and the like is a technique of readily displaying the specific portion in one electronic document, it is not easy to refer to (display) a specific portion of a different document.

For example, in order to display a specific portion of a different related PDF document during display of a certain PDF document, the following operation is performed. Specifically, an operator searches the desired different document (PDF document) relating to the certain PDF document from a number of electronic documents, and performs operation to open the different document. Thereafter, operation to select a link item corresponding to the specific portion in the different document is performed. In response to the operation, the specific portion is displayed in a body text display field of the different document. This allows the operator to cause the specific portion in the document different from the certain document to be displayed on a screen. The operation, however, is very bothersome to the user.

### SUMMARY OF THE INVENTION

An object of the present invention is to provide a technique enabling a specific portion in a plurality of documents to be efficiently referred to.

According to a first aspect of the present invention, there is provided an electronic document managing apparatus comprising a link information acquiring unit that acquires link information relating to link destinations inside each of a plurality of electronic documents, an integration unit that integrates the respective pieces of link information relating to the plurality of electronic documents to generate integrated link information, and an addition unit that adds the integrated link information to the plurality of electronic documents, respectively.

According to a second aspect of the present invention, there is provided a non-transitory computer-readable recording medium storing a computer program for performing the steps of (a) acquiring link information relating to internal link destinations of each of a plurality of electronic documents, (b) integrating the respective pieces of link information relating to the plurality of electronic documents to generate integrated link information, and (c) adding the integrated link information to the plurality of electronic documents, respectively.

According to a third aspect of the present invention, there is provided an electronic document managing apparatus comprising a reading unit that reads a plurality of electronic documents with integrated link information added thereto, the integrated link information being generated by integrating link information relating to internal link destinations of the respective electronic documents, and a display control unit that displays the integrated link information in respective link display fields of the plurality of electronic documents, wherein the plurality of electronic documents include a first electronic document and a second electronic document, in response to selection operation of the link item that is displayed in the link display field in the first electronic document and relates to a specific reference destination in the second electronic document, the display control unit displays a page including the specific reference destination of the second electronic document in a body text display field of the second electronic document, and in response to the selection operation, the display control unit displays, in the link display field of the second electronic document, the link item associated with a page displayed in a body text display field of the first electronic document immediately before the selection operation.

According to a fourth aspect of the present invention, there is provided a non-transitory computer-readable recording medium storing a computer program for performing the steps of (a) reading a first electronic document from a plurality of electronic documents with integrated link information added thereto, the integrated link information being generated by integrating link information relating to internal link destinations of the respective electronic documents, (b) displaying a plurality of link items of the integrated link information in a link display field of the first electronic document, (c) displaying, in a body text display field of a second electronic document among the plurality of electronic documents, a page including a specific reference destination of the second electronic document, in response to selection operation of the link item that is displayed in the link display field in the first electronic document and relates to the specific reference destination in the second electronic document, and (d) in response to the selection operation, displaying, in a link display field of the second electronic document, the link item associated with a page displayed in a body text display field of the first electronic document immediately before the selection operation.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing an electronic document creating operation;

FIG. 2 is a block diagram showing a schematic configuration of an electronic document managing apparatus;

FIG. 3 is a flowchart showing file creation operation of the electronic document managing apparatus;

FIG. 4 is a diagram showing a screen GA to specify a file order;

FIG. 5 is a diagram showing originals (or scan images);

FIG. 6 is a diagram showing electronic document files generated finally;

FIG. 7 is a diagram showing bookmark information of a certain electronic document file;

FIG. 8 is a diagram showing bookmark information of another electronic document file;

FIG. 9 is a diagram showing bookmark information of still another electronic document file;

FIG. 10 is a diagram showing integrated bookmark information;

FIG. 11 is a diagram showing a specification example of a link destination relating to each of the bookmark items;

FIG. 12 is a diagram showing an electronic document file generated finally;

FIG. 13 is a diagram showing another electronic document file generated finally;

FIG. 14 is a diagram showing still another electronic document file generated finally;

FIG. 15 is a flowchart relating to display operation of the electronic document files;

FIG. 16 is a diagram showing a display example after scrolling;

FIG. 17 is a diagram showing a display example after jumping to the outside of the document;

FIG. 18 is a diagram showing a display example after return jumping to an original page;

FIG. 19 is a diagram showing a display example after jumping to the inside of the document;

FIG. 20 is a diagram showing a specification example of a link destination relating to each of the bookmark items;

FIG. 21 is a diagram showing how three electronic document files are stored with a folder structure specified; and

FIG. 22 is a conceptual diagram showing electronic document creating operation according to a modification.

### DESCRIPTION OF THE PREFERRED EMBODIMENT

Hereinafter, an embodiment of the present invention is described with reference to the drawings.

<1.Apparatus Overview>

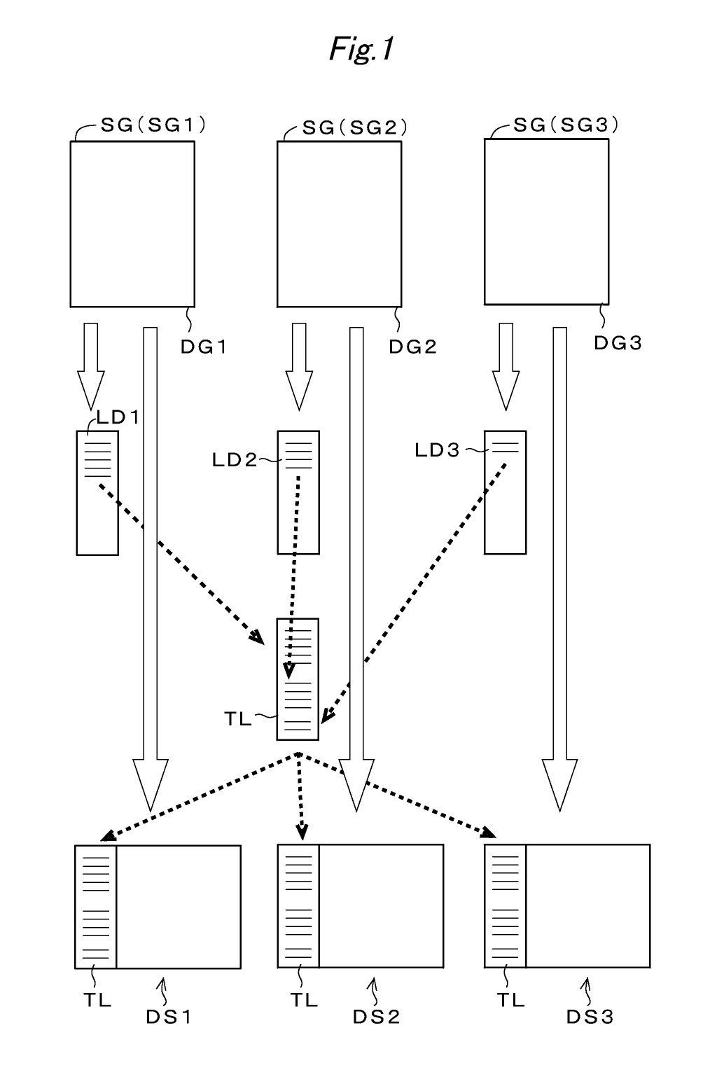

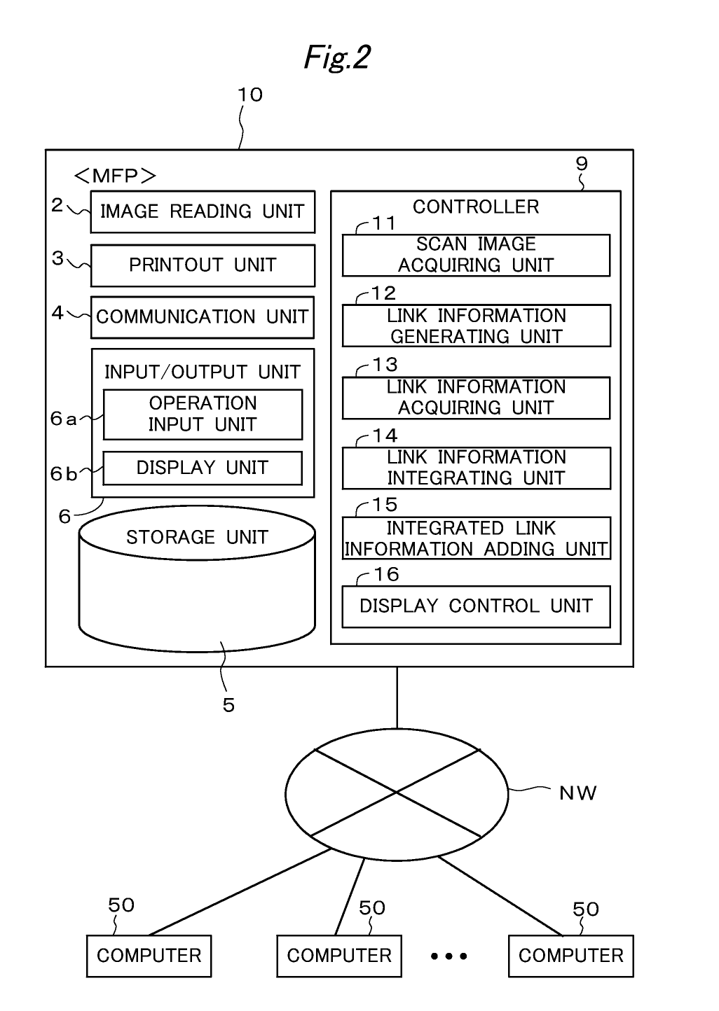

FIG. 1 is a schematic diagram showing operation relating to an electronic document managing apparatus 10 (see FIG. 2) according to this embodiment. The electronic document managing apparatus 10 is configured as a multi function peripheral (MFP). The electronic document managing apparatus 10 can execute network communication through a network NW (see FIG. 2) with various receiving apparatuses (MFPs, computers, and the like) 50. The network NW is configured by a LAN, a WAN, the Internet, and the like. Moreover, a connection condition to the network NW may be wired connection or wireless connection.

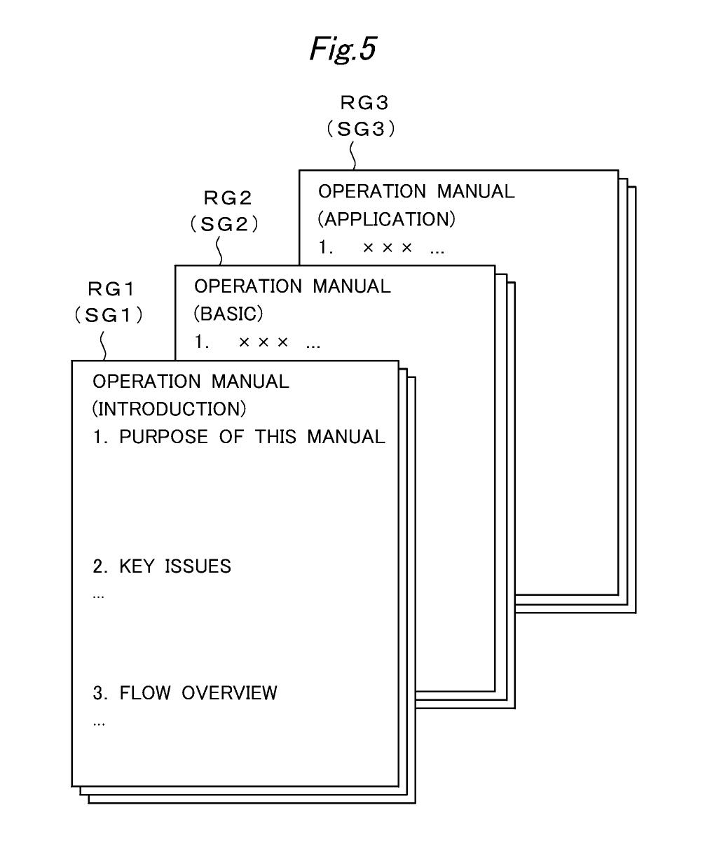

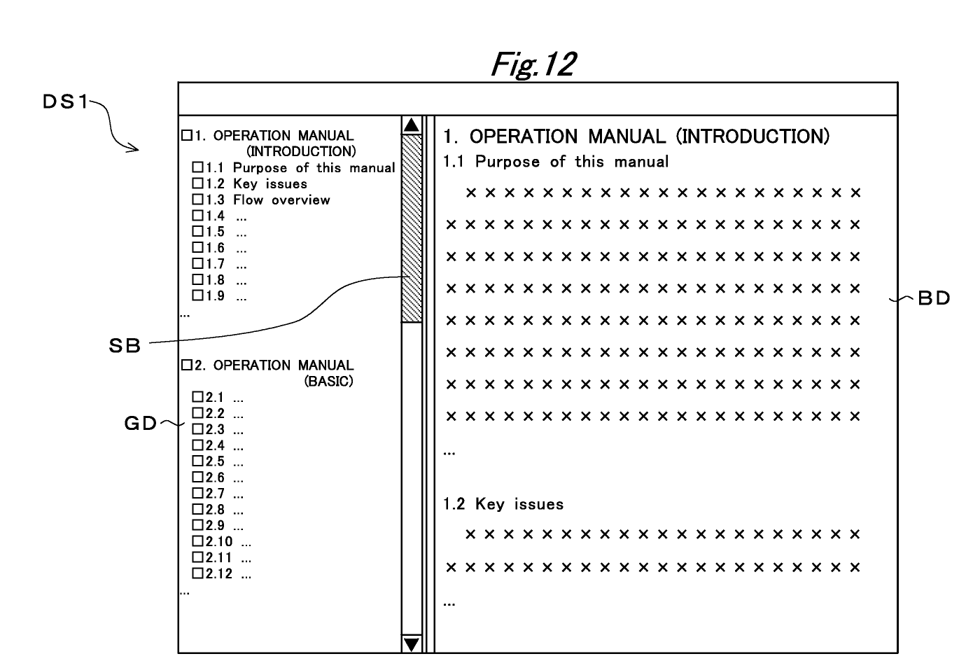

As shown in FIG. 1, this electronic document managing apparatus 10 creates an electronic document file (e.g., an electronic document file of portable document format (PDF)) DSi, based on a scan image SGi of an original RGi (see FIG. 5). Here, as the electronic document file DSi, a format having a bookmark display field (also referred to as a link display field or a table-of-contents display field) GD and a body text display field BD (e.g., a PDF file with bookmarks) is employed (see FIG. 12 and the like). The body text display field BD is a display region that displays a body text of the electronic document file DSi, and the bookmark display field GD is a display region that displays bookmark information (bookmark items and the like) of the electronic document file DSi.

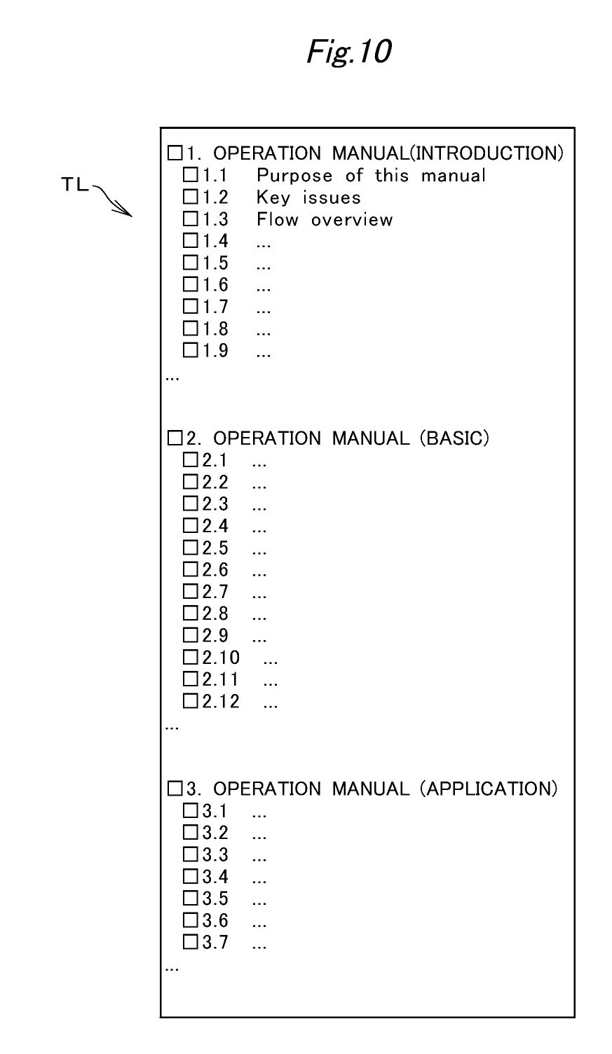

Moreover, the plurality of electronic document files DSi each have common integrated bookmark information (also referred to as integrated link information) TL (FIGS. 1, 10). The integrated bookmark information TL is generated by integrating a plurality of pieces of bookmark information relating to link destinations (also referred to as link information) LDi inside respective electronic document files DGi (see FIGS. 1, 7 to 9). Each piece of the bookmark information LDi is extracted from each of the scan images SGi.

As will be described later, since the plurality of pieces of bookmark information LDi are included in the integrated bookmark information TL, and the integrated bookmark information TL is added to the electronic document files DSi, respectively, a specific portion of a plurality of documents can be efficiently referred to. For example, jumping from an electronic document file DS1 to a link destination in a different electronic document file DS3 is enabled based on bookmark information LD3 included in the integrated bookmark information TL added to the electronic document file DS1. Moreover, jumping from the electronic document file DS3 to a link destination in the electronic document file DS1 is also enabled based on bookmark information LD1 included in the integrated bookmark information TL added to the electronic document file DS3. That is, intercommunication between the plurality of documents can be easily performed.

FIG. 2 is a block diagram showing a schematic configuration of the electronic document managing apparatus 10.

As shown in the functional block diagram in FIG. 2, this electronic document managing apparatus (MFP) 10 comprises an image reading unit 2, a printout unit 3, a communication unit 4, a storage unit 5, an input/output unit 6, a controller 9 and the like, and operates these units in a compositive manner to realize various functions.

The image reading unit 2 is a processing unit that optically reads (i.e., scans) an original placed at a predetermined position of the MFP 10 to generate image data of the original (also referred to as an original image or a scan image). This image reading unit 2 is also referred to as a scan unit.

The printout unit 3 is an output unit that prints out an image on various media such as paper, based on data relating to a printing object.

The communication unit 4 is a processing unit capable of performing facsimile communication through a public line or the like. Furthermore, the communication unit 4 enables network communication through the communication network NW. For this network communication, various protocols are utilized such as transmission control protocol/Internet protocol (TCP/IP) and file transfer protocol (FTP). The MFP 10 can transmit and receive various types of data between a desired counterpart and itself through the use of the network communication. Moreover, the MFP 10 can send and receive an electronic mail using this communication unit 4.

The storage unit 5 is configured by a storage device such as a hard disk drive (HDD). The storage unit 5 has a plurality of user boxes. Each of the user boxes is a storage region provided for each user of the MFP 10. The respective user boxes are utilized by the respective users as folder regions for electronic document management. The storage unit 5 also has a “folder for creating bookmark sharing files” (described later).

The input/output unit 6 comprises an operation input unit 6a that receives input to the MFP 10, and a display unit 6b that performs display output of various types of information. Particularly, the MFP 10 is provided with an operation panel 63 (not shown). This operation panel (touch screen) 63 is constructed by burying piezoelectric sensors and the like in a liquid crystal display panel, and functions as a part of a display unit 62 and as a part of an operation input unit 61 as well.

The controller 9 is a control device that is built into the MFP 10, and integrally controls the MFP 10. The controller 9 is configured as a computer system comprising a CPU, various semiconductor memories (RAM and ROM) and the like. The controller 9 realizes various processing units by executing, in the CPU, a software program (hereinafter, simply referred to as a program) stored in the ROM (e.g., EEPROM or the like). The program may be provided through a network, or may be provided by a non-transitory computer-readable recording medium (e.g., a USB memory (portable memory), a CD-ROM or the like).

Specifically, as shown in FIG. 2, the controller 9 realizes the various processing units including a scan image acquiring unit 11, a link information generating unit 12, a link information acquiring unit 13, a link information integrating unit 14, an integrated link information adding unit 15, and a display control unit 16.

The scan image acquiring unit 11 is a processing unit that acquires the plurality of (a plurality of groups of) scan images SGi relating to the plurality of (a plurality of groups of) originals RGi acquired by the image reading unit 2 and the like.

In this embodiment, the plurality of electronic document files DGi of a specific format (e.g., PDF) have been generated in advance, based on the scan images SGi relating to the plurality of originals RGi. The scan image acquiring unit 11 reextracts and acquires the respective scan images SGi from the respective electronic document files DGi generated in advance. However, the present invention is not limited to this, but the scan image acquiring unit 11 may instantly acquire the scan images SGi generated by the scan operation by the image reading unit 2.

The link information generating unit 12 generates the internal link information LDi relating to internal link destinations (internal reference destinations) of the respective electronic document files DGi. As described later, the link information generating unit 12 extracts bookmark items (also referred to as title items or link items) from the scan images SGi of the respective electronic document files DGi, or the like, and identifies the respective link destinations (internal link destinations) corresponding to the title items. This allows the link information (internal link information) LDi indicating the internal link destinations for each of the electronic document files DGi to be generated for each of the electronic document files DGi. The “bookmark items” of each of the electronic document files DGi are also described as the table-of-contents items of each of the electronic document files DGi.

The link information acquiring unit 13 acquires the bookmark information LDi (of each of the electronic document files DGi) generated by the link information generating unit 12.

The link information integrating unit 14 integrates respective pieces of link information LDi relating to the plurality of electronic document files DGi to generate the integrated bookmark information TL.

The integrated link information adding unit 15 adds the integrated bookmark information TL generated by the link information integrating unit 14 to the plurality of electronic document files DGi, respectively to create the plurality of electronic document files (e.g., PDF files with bookmarks) DSi.

The display control unit 16 is a processing unit that controls display operation in the display unit 6b and the like. The display control unit 16 causes body text information of each of the electronic document files DSi to be displayed on the body text display field BD (BDi) of each of the electronic document files DSi, and causes the bookmark information of each of the electronic document files DSi to be displayed in the bookmark display field GD (GDi) of each of the electronic document files DSi.

This electronic document managing apparatus 10 is also represented as an electronic document display apparatus or the like, because it can display each of the electronic document files DSi and the like in the display unit 6b.

<2. File Creation Operation>

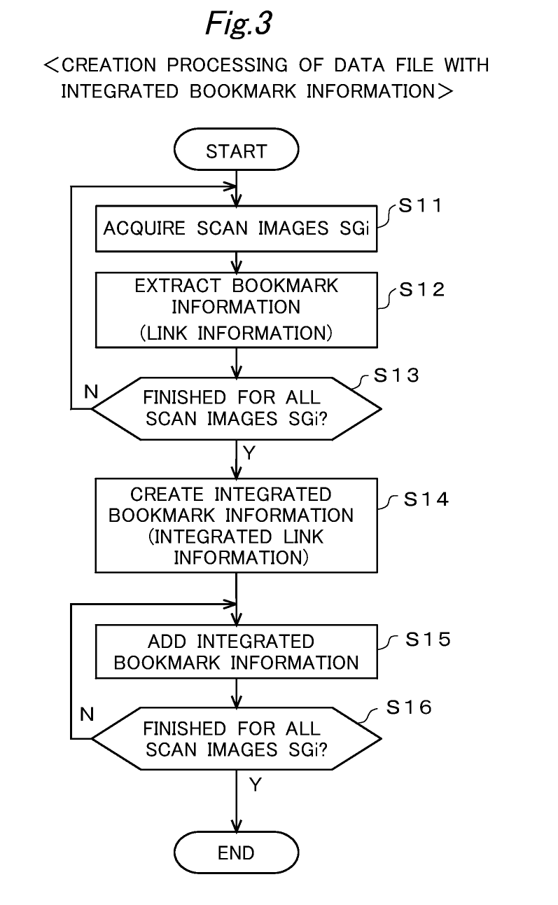

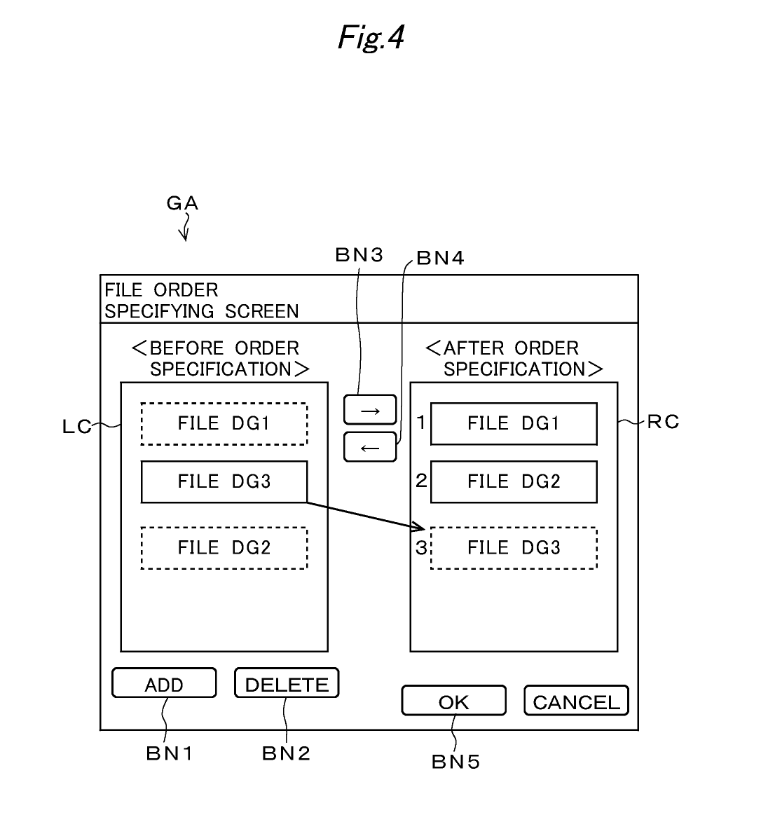

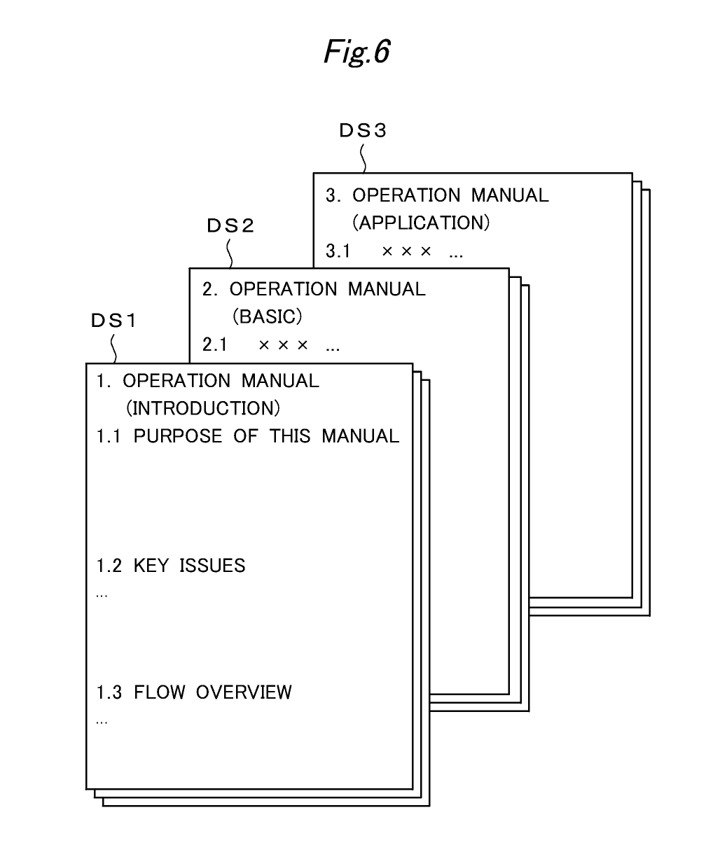

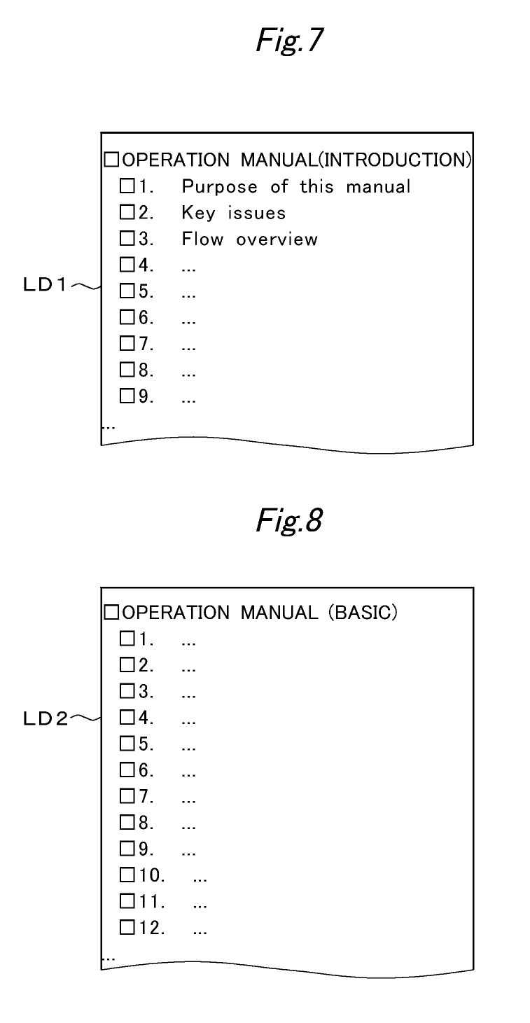

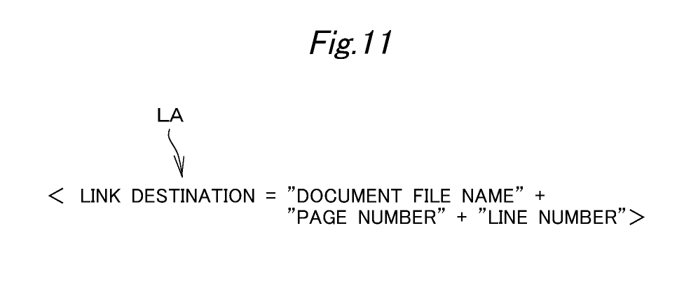

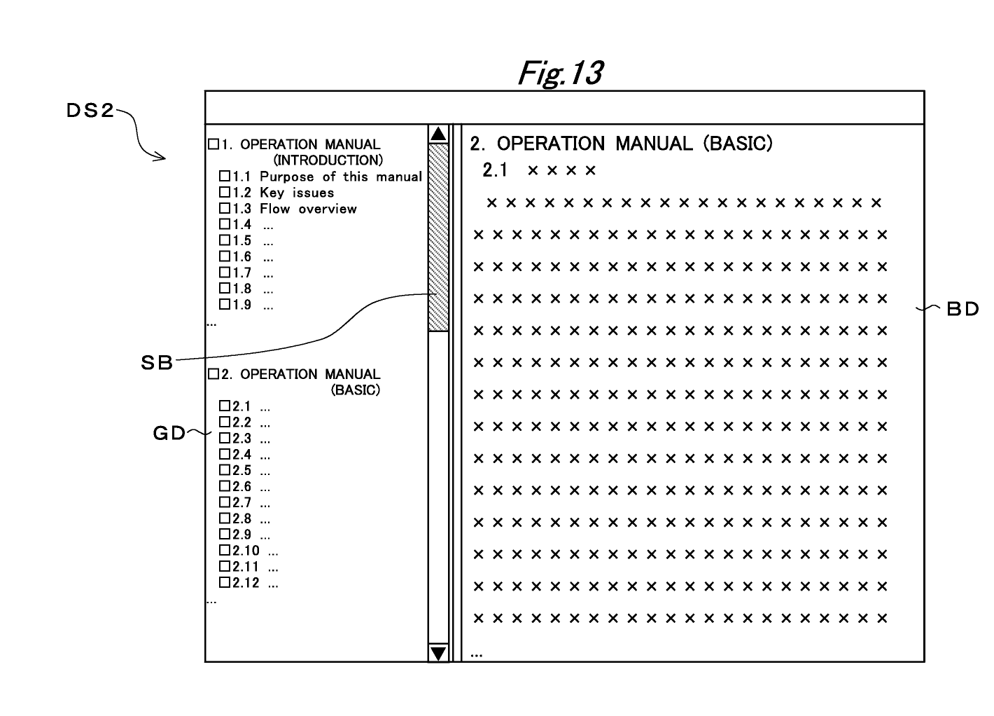

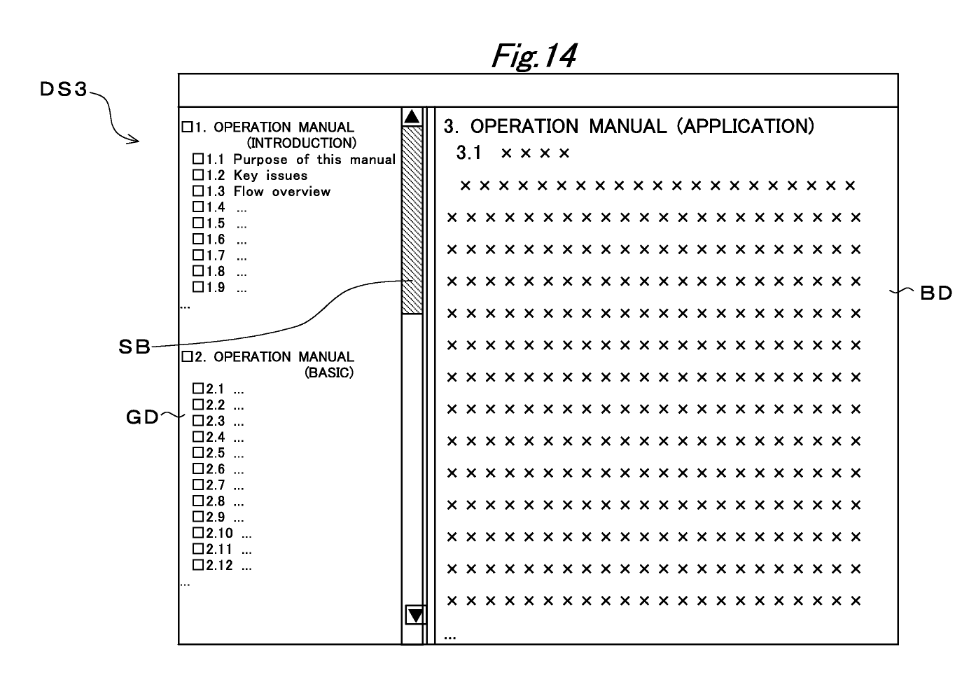

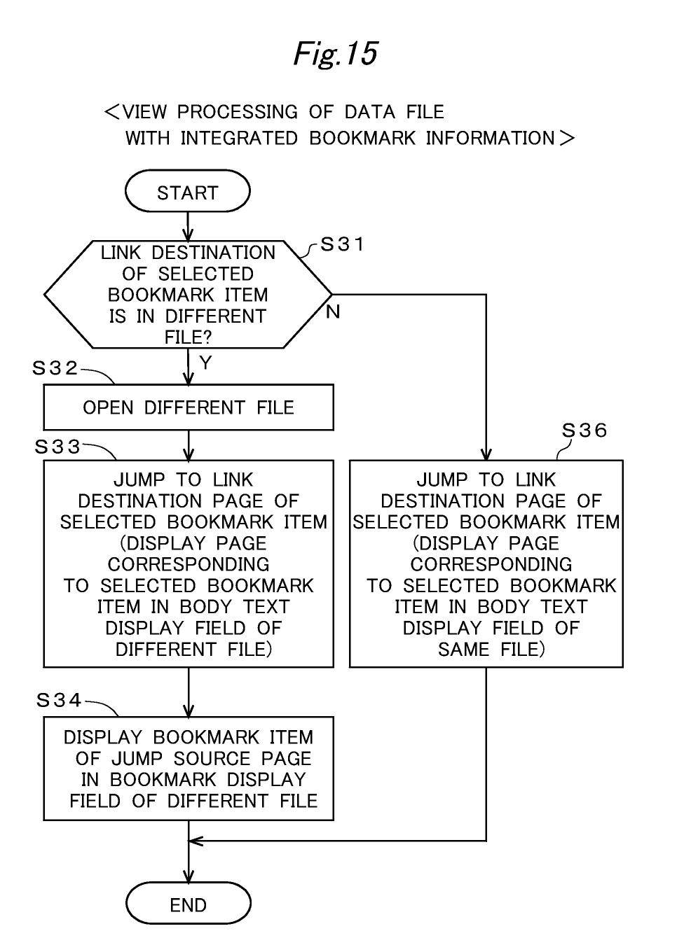

FIG. 3 is a flowchart showing file creation operation in the MFP (electronic document managing apparatus) 10. Moreover, FIG. 4 is a diagram showing a screen GA to specify a file order, FIG. 5 is a diagram showing the originals RGi (or the scan images SGi), and FIG. 6 is a diagram showing the electronic document files DSi generated finally. Furthermore, FIGS. 7 to 9 are diagrams showing the bookmark information LDi of the electronic document files DGi (i=1, 2, 3), respectively. Moreover, FIG. 10 is a diagram showing the integrated bookmark information TL, and FIG. 11 is a diagram showing a specification example of the link destination relating to each of the bookmark items. Furthermore, FIGS. 12 to 14 are diagrams showing the electronic document files DSi (i=1, 2, 3) generated finally, respectively.

Referring to these diagrams, the creation operation of the electronic document files DSi with the integrated bookmark information TL is described in detail.

Here, assume that the plurality of electronic document files DGi are generated in advance, based on the scan images SGi relating to three types of originals RGi (i=1, 2, 3) as shown in FIG. 5. Particularly, the originals RGi are scanned by the image reading unit 2 and the like, so that the scan images SGi are generated, and the electronic document files DGi are generated using the scan images SGi. Moreover, the electronic document files DGi are stored in the storage unit 5 inside the electronic document managing apparatus 10.

The operator (operating user) of the electronic document managing apparatus 10 specifies the plurality of (three in this case) electronic document files DGi as an electronic document file group to be managed as one aggregate from a number of electronic document files stored in the storage unit 5 inside the electronic document managing apparatus 10. Specifically, using the screen GA (FIG. 4) displayed in the display unit 6b, the operating user first selects and specifies the three generated electronic document files DGi from the storage unit 5. Particularly, the operating user presses an addition button BN1 (FIG. 4) on the screen GA to cause the display unit 6b to display a screen for file selection (not shown) and select a desired electronic document file DG1 as an additional file. According to this selection operation, a file name of the electronic document file DG1 is additionally displayed on a list field LC on the left side of the screen GA. Thereafter, the similar operation is repeated to thereby sequentially select the other two electronic document files DG3, DG2 as additional files and display the same in the list field LC on the left side of the screen GA. Pressing a delete button BN2 on the screen GA allows the file name of the selected electronic document file from the list field LC.

By the above-described operation, it is specified that the three electronic document files DSi are to be stored in the “folder for creating bookmark sharing files”.

Furthermore, the operating user specifies the order of the respective electronic document files DGi in the electronic document file group, using buttons BN3, BN4. Specifically, when the electronic document file DG1 is selected and the button BN3 is pressed by the operating user, the file name of the electronic document file DG1 is moved from the left list field LC to a right list field RC. Similarly, the file names of the other electronic document files DG2, DG3 are sequentially moved from the left list field LC to the right list filed RC in accordance with the order of the electronic document file group. Pressing the button BN4 reversely moves the file name of the selected electronic document file from the right list field RC to the left list field LC, which enables correction operation relating to the order specification.

FIG. 4 shows a state where the three electronic document files DG1, DG2, DG3 are arrayed in the right list field RC in this order from top in accordance with the specification order in the electronic document file group using the above order specification operation.

Thereafter, pressing an OK button BN5 executes the operation in step S11 and later in FIG. 3.

First, in steps S11 to S13, the bookmark information (internal link information) LDi of the respective electronic document files DGi is extracted, based on the scan images SGi reextracted from the plurality of (in this case, three) electronic document files DGi in the electronic document file group.

Particularly, in step S11, the scan images SGi are reextracted from the electronic document files DGi, and in step S12, the “bookmark information LDi” is extracted from the scan images SGi.

In step S12, the link information generating unit 12 extracts character information included in the scan images SGi by an optical character reading technique (character recognition technique) (specifically, a technique of an optical character reader (OCR), and extracts the bookmark items (title items) from the character information on predetermined criteria. Particularly, a character string having a predetermined title format is extracted as a character string of the title item. As the character string having the predetermined title format, for example, there are exemplified a character string of a line having a numeric character(s) (“1.”, “1.1” or the like) at the beginning (left end) of a sentence (left-aligned character string beginning with the numeric character(s)), a character string of one line having a bold face attribute (left-aligned character string having a bold face attribute), and the like. As a result, the link information generating unit 12, for example, extracts character strings of “Operation manual (introduction)”, “1. Purpose of this manual”, “2. Key issues” and the like from the scan images SGi (see FIG. 5) as the bookmark items (title items).

Moreover, the respective bookmark items are hierarchized and acquired. Specifically, the bookmark item of the “Operation manual (introduction)” is acquired as the bookmark item of the highest hierarchy (first hierarchy), and the bookmark items of “1. Purpose of this manual”, “2. Key issues” and the like are acquired as the bookmark items of the next hierarchy (second hierarchy).

Moreover, the link information generating unit 12 identifies the link destination corresponding to each of the bookmark items (particularly, a page in which contents corresponding to each of the bookmark items are displayed) to generate the bookmark information LDi. Specifically, location information indicating an arrangement site (location) of the character string of each of the bookmark items (title items) (particularly, a page number and a line number in the electronic document file DGi) is acquired as the information of the link destination corresponding to the title item. For example, the information indicating that the link destination of the bookmark item, “Operation manual (introduction)” is “the first line of the first page in the electronic document file DS1” is acquired as the information of the link destination corresponding to the bookmark item. Similarly, the information indicating that the link destination of the bookmark item, “1. Purpose of this manual” is “the second line of the first page in the electronic document file DS1” is acquired as the information of the link destination corresponding to the bookmark item.

Moreover, in step S12, the bookmark information LDi is generated by the link information generating unit 12 as described above, and the bookmark information LDi is acquired by the link information acquiring unit 13.

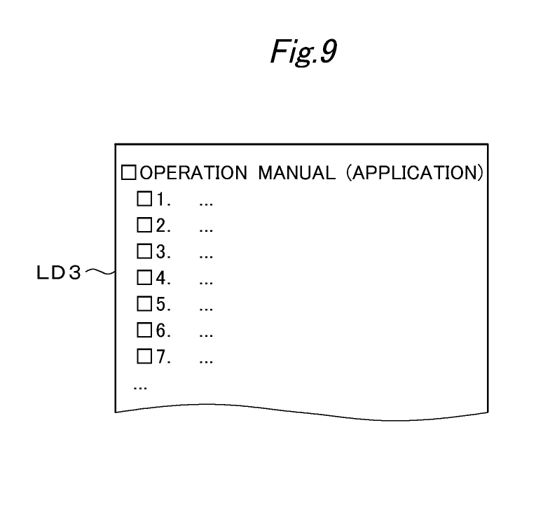

The above-described processing (steps S11, S12) is repeated until it is determined in step S13 that this processing for all the scan images SGi has been finished. As a result, the bookmark information LDi is extracted and acquired from the respective scan images SGi. Specifically, the bookmark information LD1 (FIG. 7) is extracted and acquired from the scan image SG1, the bookmark information LD2 (FIG. 8) is extracted and acquired from the scan image SG2, and the bookmark information LD3 (FIG. 9) is extracted and acquired from the scan image SG3.

Thereafter, in step S14, the integrated bookmark information (FIG. 10) TL is generated, based on the bookmark information LD1, LD2, and LD3. The integrated bookmark information TL is generated by integrating the three pieces of bookmark information LD1, LD2, and LD3.

A hierarchical structure relating to the bookmark items in the integrated bookmark information TL is reconstructed, utilizing information of a hierarchical structure relating to the bookmark items in each piece of the bookmark information LDi.

Specifically, in the integrated bookmark information TL, the documents of the respective electronic document files DGi (DSi) are handled as documents of different chapters from one another. Particularly, the link information integrating unit 14 gives, in the integrated bookmark information TL, a table of contents of “the first chapter” to the link items of the electronic document file DG1 (DS1). Similarly, the link items of the electronic document file DG2 (DS2) are given a table of contents of a chapter different from the first chapter (more specifically, a chapter following the first chapter, that is, “the second chapter”), and the link items of the electronic document file DS3 are given a table of contents of still another chapter (“the third chapter”). For example, the highest bookmark item of the electronic document file DG1, “Operation manual (introduction)” is altered to “1. Operation manual (introduction)”. Moreover, the highest bookmark item of the electronic document file DG2, “Operation manual (basic)” is altered to “2. Operation manual (basic)”.

In the integrated bookmark information TL, a hierarchical level in the original bookmark information LDi shifts by one in a lower direction.

Specifically, the original “chapter” in the bookmark information LDi is changed into a “section” (a table-of-contents level in one lower hierarchy) in the integrated bookmark information TL. For example, the bookmark item in the bookmark information LD1, “1. Purpose of this manual” (the first chapter) is changed into a bookmark item, “1.1 Purpose of this manual” (the first section of the first chapter). Moreover, a bookmark item in the bookmark information LD3, “4. File management” (the fourth chapter) is changed into a bookmark item, “3. 4 File management” (the fourth section of the third chapter).

In this manner, the link information integrating unit 14 updates table-of-contents item numbers (order numbers) of the “bookmark items” included in the bookmark information LDi of each of the electronic document files DSi to generate table-of-contents information and the like in the integrated bookmark information TL. Particularly, the link information integrating unit 14 gives different chapter numbers in the plurality of electronic document files DSi respectively to generate the table-of-contents information relating to the plurality of link items of the integrated bookmark information TL. Moreover, the generated (changed) table-of-contents item is reflected on the name of the title item in the body text. For example, as shown in FIG. 6 (see FIG. 12 as well), the item in the body text before the change, “Operation manual (introduction)” (FIG. 5) is changed into “1. Operation manual (introduction)”. Similarly, the item in the body text before the change, “1. Purpose of this manual” is changed into “1.1 Purpose of this manual”.

Moreover, as shown in FIG. 11, information LA indicating the link destination of each of the bookmark items is configured as information including, for example, a “document file name”, a “page number”, and a “line number”. This information LA is attached to the bookmark item to be stored in the integrated bookmark information TL. The information LA, however, is attached to the bookmark item in a non-visualized (invisible) state. As described later, when one of the bookmark items in the bookmark display field GD is selected by the operating user, the location of the link destination is identified based on the above-described information LA, and the contents (body text) of the link destination of the bookmark item are displayed in the text body display field BD in accordance with the selection operation. That is, in accordance with the selection operation, operation to jump to a corresponding location (line) of a corresponding page is executed.

Once the integrated bookmark information TL is created by the processing in step S14, the processing advances to step S15. In step S15, the integrated link information adding unit 15 adds the integrated bookmark information TL to each of the electronic document files DGi to create each of the electronic document files DSi. This addition operation is performed for all the electronic document files DGi (DSi). As a result, the electronic document files DS1, DS2, DS3 as shown in FIGS. 12, 13 and 14 are created (see FIG. 6 as well).

<3. File View Operation>

Next, referring to a flowchart of FIG. 15, view operation of the respective electronic document files DSi is described. FIG. 15 is a flowchart showing a part of display operation (view operation) of the electronic document files DSi. The display operation in FIG. 15 is executed by the display control unit 16 and the like.

As shown in FIG. 12, in the electronic document managing apparatus (MFP) 10, when operation to “open” the electronic document file DS1 is performed by the operator, the electronic document file DS1 is displayed in the display unit 6b. Particularly, in a window to display the electronic document file DS1 (display window of the electronic document file DS1), the bookmark display field GD and the body text display field BD are displayed.

In the body text display field BD, the body text of the electronic document file DS1 is displayed. Specifically, a text of opening of the electronic document file DS1 (text beginning with “1. Operation manual (introduction)”) is displayed from top down in the body text display field BD.

Moreover, in the bookmark display field GD, the plurality of bookmark items in the integrated bookmark information TL of the electronic document file DS1 are hierarchized to be displayed. The plurality of bookmark items in the integrated bookmark information TL are displayed in accordance with the predetermined order (chapter number order (item number order)) from the upper side to the down side of the bookmark display field GD. Specifically, the contents of the integrated bookmark information TL including all pieces of the bookmark information TL1, TL2, TL3 of the plurality of electronic document files DS1, DS2, DS3 are sequentially displayed from top down.

Moreover, operating a scroll bar SB on the right side of the bookmark display field GD enables the display of the bookmark display field GD to be scrolled. This allows the invisible “bookmark items” to be displayed by scrolling, even when all the information cannot be displayed at a certain point because of a length in the vertical direction of the bookmark display field GD.

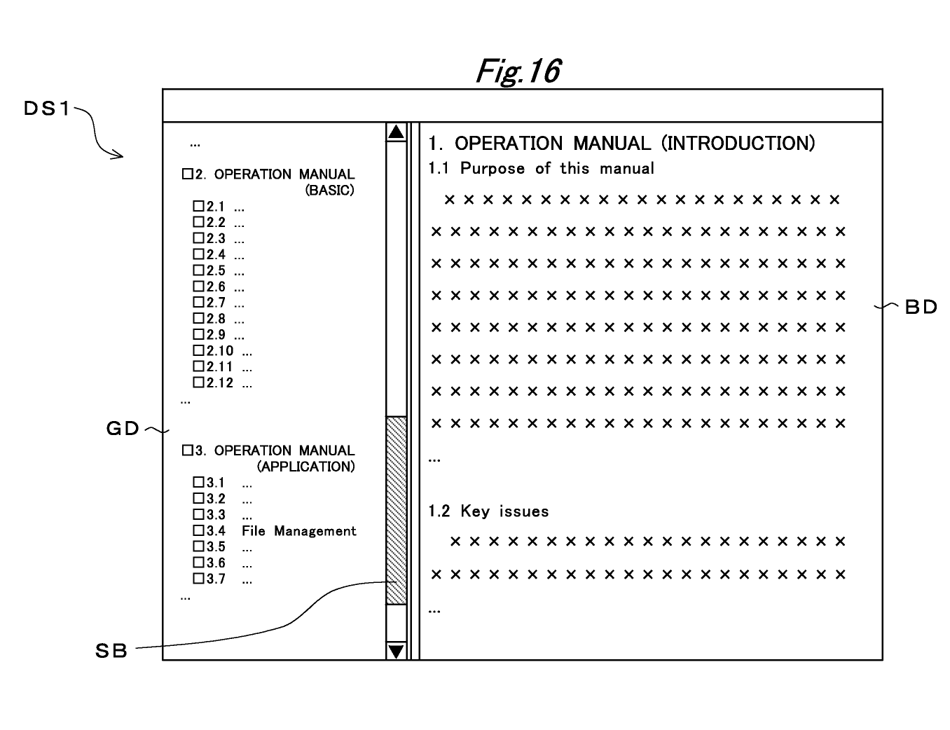

FIG. 16 is a diagram showing a state where the bookmark information on the relatively lower side is displayed in the bookmark display field GD by operating the scroll bar SB. In the bookmark display field GD in FIG. 16, the bookmark information TL2 of the electronic document file DS2 and the bookmark information TL3 of the electronic document file DS3 are mainly displayed.

The operator causes the desired bookmark item to be displayed in the bookmark display field GD by the above-described operation of the scroll bar SB, and then, selects the desired bookmark item so as to cause the display unit 6b to display a page corresponding to the bookmark item.

Once the selection operation of the desired bookmark item (e.g., operation of touching a bookmark item portion of interest on the operation panel 63) is executed by the operating user, the electronic document managing apparatus 10 executes the operation shown in the flowchart of FIG. 15.

First, in step S31, it is determined whether or not the link destination of the selected “bookmark item” (selected bookmark item) is in the same file (inside the file) or in the different file (outside the file). This determination operation is executed, based on the file name of the current document file and the file name of the link destination document corresponding to the selected bookmark item, which file name is indicated in the information LA (FIG. 11).

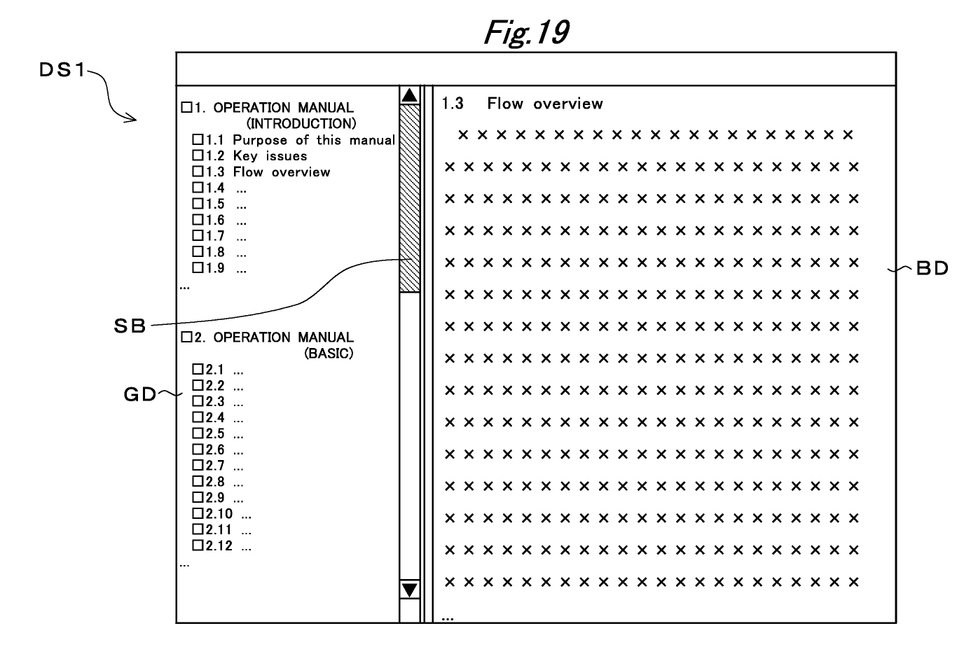

If the link destination of the selected bookmark item is in the same file, the processing advances to step S36. In step S36, processing of jumping to the link destination page of the selected bookmark item (the page associated with the bookmark item of interest) is executed. Specifically, in accordance with the selection operation of the user, the page corresponding to the selected bookmark item is displayed in the body text display field BD. For example, when the bookmark item, “1. 3 Flow overview” is selected in FIG. 12, a page of a body text corresponding to the bookmark item, “1. 3 Flow overview” is displayed in the body text display field BD, as shown in FIG. 19. This jump processing (display processing of the link destination) is executed, based on the link destination information LA (FIG. 11) associated with the bookmark item.

On the other hand, if the link destination of the selected bookmark item is outside the file, the processing advances to step S32. Here, assume that in the bookmark display field GD in FIG. 16, the bookmark item, “3.4 File management” is selected. The bookmark item “3.4 File management” is also described as a bookmark item (link item) that is displayed in the bookmark display field (link display filed) GD in the electronic document file DS1, and that indicates that a specific link destination (reference destination) in the different electronic document file DS3 is to be referred to.

In steps S32, S33, S34, the processing of jumping to the link destination page (particularly, the page in the external file) of the selected bookmark item, or the like is executed in accordance with the selection operation of the user.

Specifically, first, in step S32, processing of “opening” the different file (electronic document file D53) of the link destination of the selected bookmark item is executed. This allows the contents and the like of the electronic document file DS3 to be displayed in a display window of the electronic document file DS3.

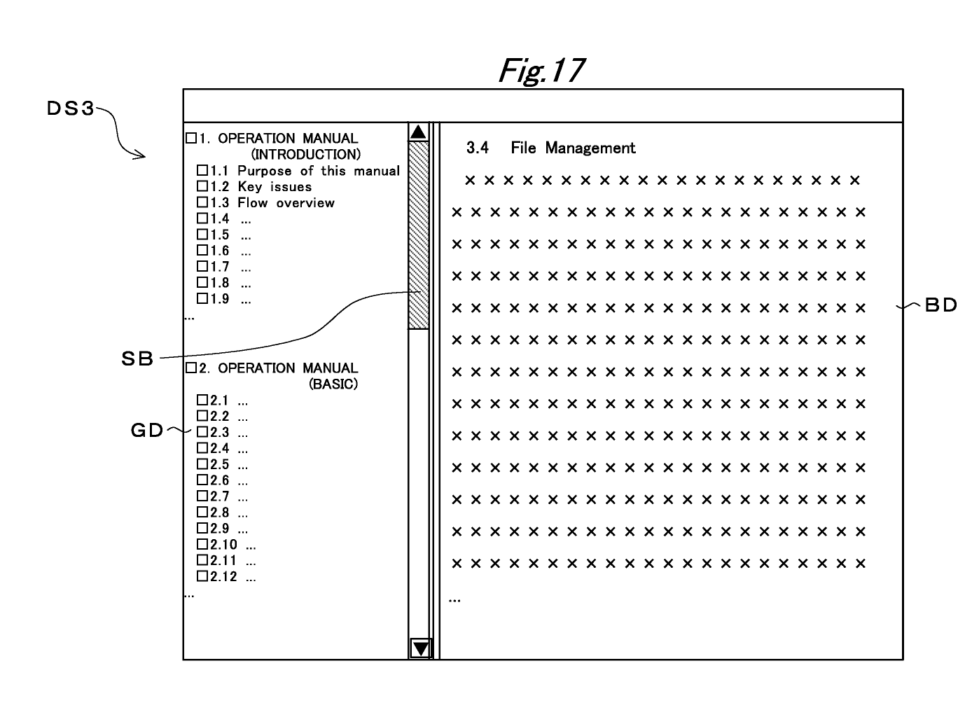

In the next step S33, the page including the link destination (reference destination) in the different file (electronic document file D53) is displayed in the body text display field BD (see FIG. 17). Specifically, as shown in FIG. 17, the page of the body text corresponding to the selected bookmark item, “3.4 File management” is displayed in the body text display field BD of the electronic document file DS3. The above-described display processing of the link destination (also referred to as jump processing) is executed, based on the link destination information LA (FIG. 11) corresponding to the selected bookmark item.

In this manner, in response to the selection operation of the bookmark item, “3. 4 File management”, the page including the specific reference destination of the different electronic document file DS3 is displayed in the body text display field BD in the display window of the electronic document file DS3. The display window of the electronic document file DS3 may be the same as the display window of the electronic document file DS1, or may be generated newly aside from the display window of the electronic document file DS1.

The above-described display operation is executed in response to the selection operation by the user.

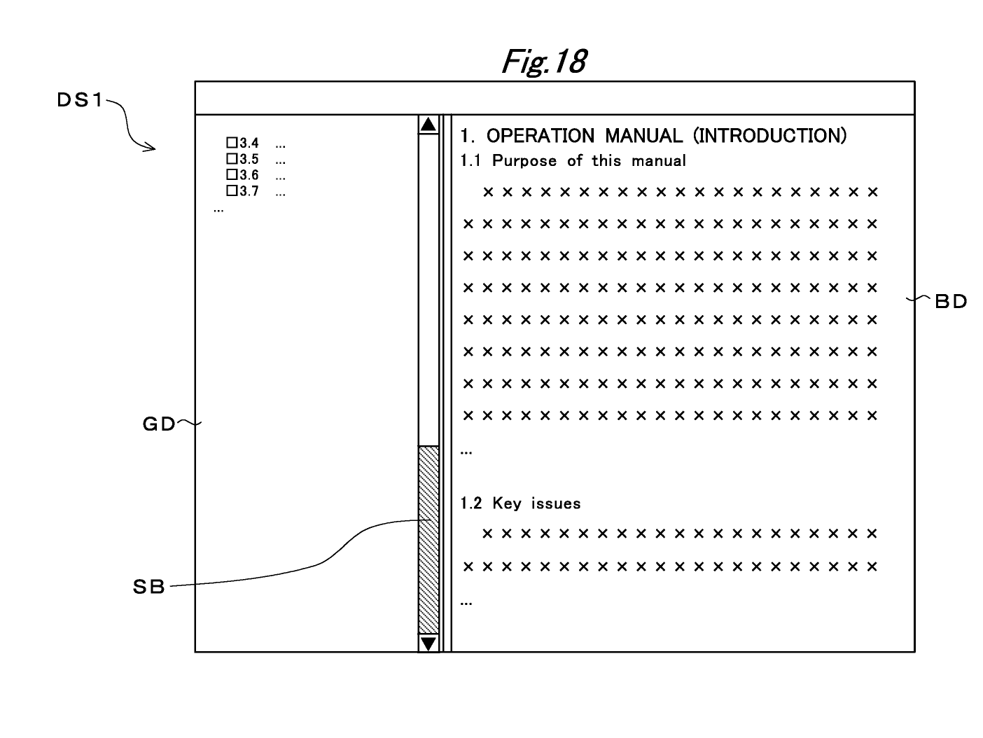

Moreover, in FIG. 17, the link item (bookmark item) corresponding to the page of the jump source is displayed in the bookmark display field GD. Accordingly, the operating user selects the link item (e.g., “1. Operation manual (introduction)”) to thereby again display the originally displayed page of the electronic document file DS1 (FIG. 18) with ease. In other words, the original link destination of the electronic document file DS1 before jumping can be efficiently referred to from the electronic document file DS3 after jumping.

Specifically, when the selection operation to the bookmark item of the bookmark display field GD of the electronic document file DS3, “1. Operation manual (introduction)” is performed, the operation in FIG. 15 is executed, so that the display screen as described in FIG. 18 is displayed in the display unit 6b (operation panel 63). Particularly, in the body text display field BD of the electronic document file DS1, the page corresponding to “1. Operation manual (introduction)” is again displayed. Moreover, in the bookmark display field GD of the electronic document file DS1, the plurality of bookmark items including the bookmark item, “3.4 File management” are displayed. This makes it possible to easily perform the selection operation of the bookmark item, “3.4 File management” again, and in accordance with the selection operation, once again, the originally displayed page of the electronic document file DS3 (FIG. 17) can also be displayed easily.

While the case where the electronic document files DSi are viewed in the electronic document managing apparatus (MFP) 10 is exemplified, the present invention is not limited to this. For example, when the electronic document files DSi are viewed, using viewer software (software for viewing the electronic document files DSi) executed in the computer 50, the above-described idea can be applied. In this case, in response to selection operation (e.g., mouth operation or the like) of the desired bookmark item by the operating use of the computer 50, operation similar to that in the flowchart of FIG. 15 may be executed in the computer 50.

<4. File Copy Operation>

The electronic document files DSi created as described above may be copied or moved from the electronic document managing apparatus 10 to the different computer 50 or the like. Specifically, the operating user can operate the operation input unit 6a and the like of the electronic document managing apparatus (MFP) 10 to copy the electronic document files DSi (i=1, 2, 3) to the different computer 50. The plurality of electronic document files DSi may be stored collectively in a same folder in a storage unit of the computer 50, or may be dispersed and stored in different folders in the storage unit of the computer 50.

When the three electronic document files DS1, DS2, DS3 are copied to the different computer 50, the electronic document managing apparatus 10 alters the integrated bookmark information TL (TLi) in each of the electronic document files DSi as follows, and then executes the copy operation.

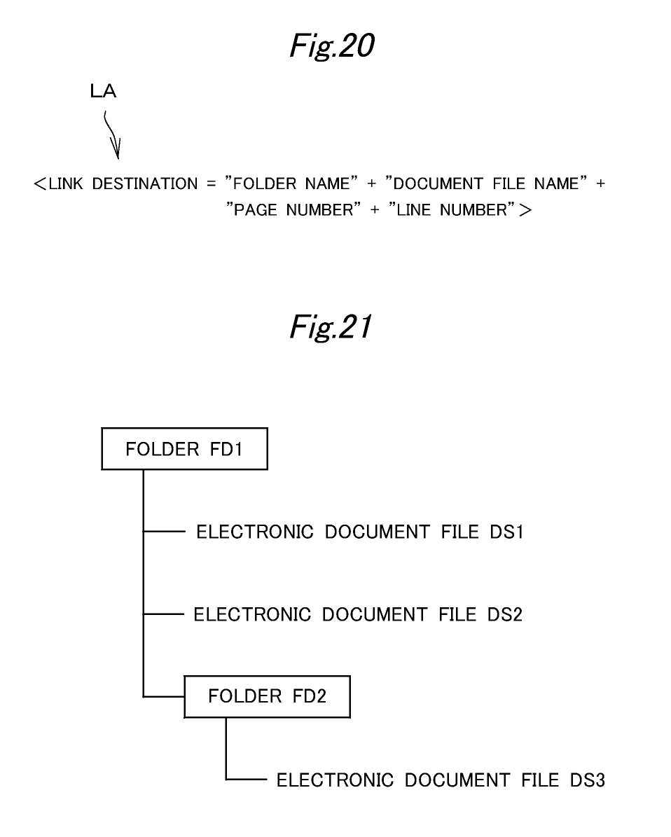

Specifically, as shown in FIG. 20, as the information LA indicating the link destination, a “folder name” is further added to the original information as shown in FIG. 11 (i.e., the “document file name”, the “page number”, and the “line number”. This “folder name” is a name of a folder to store the electronic document file DSi of the link destination in.

This folder name is preferably given by relatively specification technique (relative pass specification).

Here, assume that the three electronic document files DS1, DS2, DS3 are stored with a folder structure (folder configuration) as shown in FIG. 21 specified. In FIG. 21, among the three electronic document files DS1, DS2, DS3, the electronic document files DS1, DS2 are stored in a predetermined parent folder FD1, and the electronic document file DS3 is stored in a child folder (subfolder) FD2, which is one lower than the parent folder FD1.

In this case, to each of the bookmark items of each piece of the integrated bookmark information TL (TLi) of each of the electronic document files DSi, the following folder name may be given as storage destination folder information of the link destination document.

First, in the integrated bookmark information TL of the electronic document file DS1, the folder name relating to the link destination in the electronic document files DS1, DS2 stored in the same folder FD1 (the storage destination folder information of the link destination documents DS1, DS2) may be expressed with a sign (e.g., “ [symbol] ”) indicating a current folder. On the other hand, the folder name relating to the link destination in the electronic document file DS3 stored in the child folder FD2 (the storage destination folder information of the link destination document DS3) may be expressed by information in which the name of the child folder FD2 follows the sign indicating the current folder (e.g., “. [symbol] folder FD2”).

In the integrated bookmark information TL of the electronic document file DS2, the above-described configuration is applied.

In contrast, in the integrated bookmark information TL of the electronic document file DS3, the folder name indicating the link destination in the electronic document files DS1, DS2 stored in the parent folder FD1 (the storage destination folder information of the link destination documents DS1, DS2 may be expressed with a sign indicating a parent folder (e.g., “. [symbol] ” (double dots+“ [symbol] ”)). On the other hand, the folder name relating to the link destination in the electronic document file DS3 stored in the same folder FD2 (the storage destination folder information of the link destination document DS3) may be expressed with the sign indicating a current folder (e.g., “. [symbol] ” (single dot+“ [symbol] ”)).

As described above, the link destination information LA indicating the link destination of each of the link items in the integrated bookmark information TL is specified and generated, using the storage destination folder information of the electronic document of the link destination of interest as well. This enables the plurality of electronic document files DSi to be mutually referred to, even when the three electronic document files DS1, DS2, DS3, which are desired to be managed integrally, are arranged in the different folders in the computer 50. That is, it is possible to achieve a good balance between securement of a freedom degree of the saving destinations of the plurality of electronic document files and mutual reference between the plurality of electronic document files.

Moreover, similarly, when the three electronic document files DS1, DS2, DS3 are moved to a certain computer 50, the electronic document managing apparatus 10 updates the link information, as described above, and then executes the movement operation.

While here, the case where the electronic document files DSi (i=1, 2, 3) are copied to the different computer 50, and the like by operating the electronic document managing apparatus (MFP) 10, or the like is exemplified, the present invention is not limited to this. For example, when using file management software (software for managing the electronic document files DSi) executed in the computer 50, the electronic document files DSi are copied or moved, the above-described idea can also be applied.

<5. Effects in the Embodiment>

According to the operation as described above, since the respective pieces of bookmark information LDi of the plurality of the electronic document files DSi are included in the integrated bookmark information TL, and the integrated bookmark information TL is added to the plurality of electronic document files DSi, respectively, the respective link destinations in the plurality of electronic document files DSi can be efficiently referred to. Accordingly, user-friendliness can be enhanced.

Particularly, in the above-described aspect, the mutual reference between the plurality of electronic documents is easy. For example, jumping from the electronic document file DS1 to the link destination in the electronic document file DS3 based on the link information TL3 included in the integrated bookmark information TL added to the electronic document file DS1 (FIG. 16→FIG. 17) is enabled. Moreover, in reverse, jumping from the electronic document file DS3 to the link destination in the electronic document file DS1 based on the bookmark information LD1 included in the integrated bookmark information TL added to the electronic document file DS3 (FIG. 17→FIG. 16) is also enabled. To put it briefly, a freedom degree of intercommunication between the plurality of documents is high.

Moreover, in the above-described aspect, the electronic document files DSi are managed as separate files. In contrast, it can be considered to manage the plurality of electronic document files DSi collectively as one file. However, in this case, a size of the one file is increased, thereby causing a problem that time required for file opening is increased even when only a certain part of the file is desired to be referred to, and so on. On the other hand, in the above-described aspect, since the files are dispersed to be stored, thereby avoiding the increase in size of the file including the part of interest, the increase of the time required for file opening when the part of interest is viewed can be suppressed. That is, easiness of handling of the respective electronic document files DSi can also be secured.

Moreover, since the plurality of electronic documents DSi are not collected into one file, but are managed as the separate files, combination of the plurality of electronic document files DSi can also be changed to create one electronic document file group with the new integrated bookmark information TL added thereto. For example, managing by combining only the electronic document files DS1, DS2, managing by combining only the electronic document files DS1, DS3, managing by combining the electronic document files DS1, DS2 and another electronic document file DS4, and so on are enabled. The new integrated bookmark information TL in accordance with the combination may be added to the respective electronic document files DSi. This makes it easy to manage the plurality of electronic documents in appropriate combination set for each operating user, and to mutually refer to plurality of electronic documents.

<6. Modifications and the like>

While in the foregoing, the embodiment of this invention has been described, this invention is not limited to the above-described contents.

For example, while in the above-described embodiment, the case where the scan images SGi are generated in advance has been described, the present invention is not limited to this. Specifically, the scan operation for the plurality of originals RGi may be sequentially executed in accordance with the operation of the user to create the scan images SGi, and subsequently, the above-described processing (FIG. 3) may be further executed. In this case, it is preferable to decide the order of the bookmark items in accordance with the scan order of the plurality of originals RGi.

Moreover, while in the above-described embodiment, the case where the integrated bookmark information TL relating to the plurality of electronic documents is created collectively (FIG. 3) is exemplified, the present invention is not limited to this. For example, the integrated bookmark information TL may be gradually created at the time point where each of the scan images SGi is acquired. Specifically, when the scan operation of the plurality of originals RGi is sequentially executed in accordance with the operation of the user, the i-th scan image SGi is created, and the bookmark information LDi is extracted from the scan image SGi to tentatively create the integrated bookmark information TL including up to the i-th bookmark information LDi. Similar operation may be repeated to thereby create the integrated bookmark information TL including the respective pieces of bookmark information LDi of all the scan images SGi.

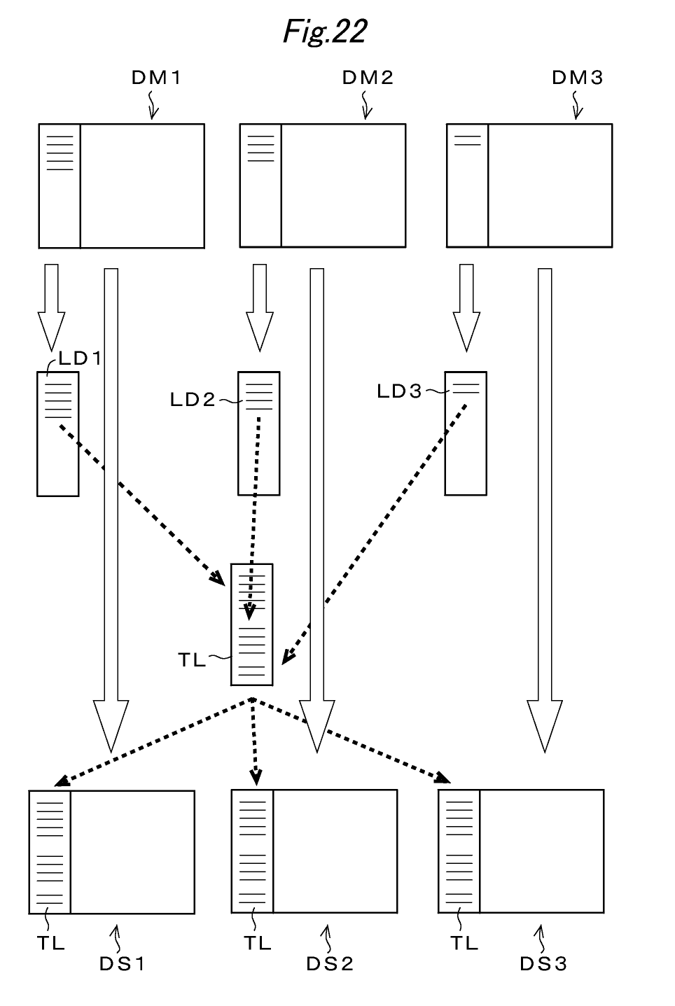

Moreover, while in the above-described embodiment, the case where the PDF files DSi are created based on the scan images SGi is exemplified, the present invention is not limited to this. For example, based on a plurality of PDF files DMi with bookmarks electronically created using a predetermined application software program (document creation software or the like) instead of scan operation, the foregoing plurality of PDF files DSi with bookmarks may be created. Specifically, as shown in FIG. 22, the electronic document managing apparatus 10 may extract respective pieces of the bookmark information LDi from the plurality of PDF files DMi to create the integrated bookmark information TL, and may add the integrated bookmark information TL to the respective PDF files DMi.

While the invention has been shown and described in detail, the foregoing description is in all aspects illustrative and not restrictive. It is therefore understood that numerous modifications and variations can be devised without departing from the scope of the invention.

What is claimed is:

1. An electronic document managing apparatus comprising:
a link information acquiring unit that acquires link information relating to link destinations inside each of a plurality of electronic documents;
an integration unit that integrates the respective pieces of link information relating to the plurality of electronic documents to generate integrated link information; and
an addition unit that adds the integrated link information to the plurality of electronic documents, respectively.

2. The electronic document managing apparatus according to claim 1, further comprising a display control unit that displays a plurality of link items of the integrated link information in respective link display fields of the plurality of electronic documents.

3. The electronic document managing apparatus according to claim 2,
wherein the plurality of electronic documents include a first electronic document and a second electronic document, and
in response to selection operation of the link item that is displayed in the link display field in the first electronic document and relates to a specific reference destination in the second electronic document, the display control unit displays a page including the specific reference destination of the second electronic document, in a body text display field of the second electronic document.

4. The electronic document managing apparatus according to claim 3, wherein in response to the selection operation, the display control unit displays, in the link display field of the second electronic document, the link item associated with a page displayed in a body text display field of the first electronic document immediately before the selection operation.

5. The electronic document managing apparatus according to claim 1, wherein the integration unit gives a different chapter number to each of the plurality of electronic documents to generate table-of-contents information relating to a plurality of link items of the integrated link information.

6. The electronic document managing apparatus according to claim 1, wherein the integration unit generates link destination information indicating a link destination of each link item in the integrated link information, using storage destination folder information of the electronic document of the link destination.

7. A non-transitory computer-readable recording medium storing a computer program for performing the steps of;
(a) acquiring link information relating to internal link destinations of each of a plurality of electronic documents;
(b) integrating the respective pieces of link information relating to the plurality of electronic documents to generate integrated link information; and
(c) adding the integrated link information to the plurality of electronic documents, respectively.

8. The recording medium according to claim 7,
wherein the computer program further performs the step of:
(d) displaying a plurality of link items of the integrated link information in respective link display fields of the plurality of electronic documents.

9. The recording medium according to claim 8,
wherein the plurality of electronic documents include a first electronic document and a second electronic document, and
in the step (d), in response to selection operation of the link item that is displayed in the link display field in the first electronic document and relates to a specific reference destination in the second electronic document, a page including the specific reference destination of the second electronic document is displayed in a body text display field of the second electronic document.

10. The recording medium according to claim 9,
wherein in the step (d), in response to the selection operation, the link item associated with a page displayed in a body text display field of the first electronic document immediately before the selection operation is displayed in the link display field of the second electronic document.

11. The recording medium according to claim 7,
wherein in the step (b), a different chapter number is given to each of the plurality of electronic documents to generate table-of-contents information relating to a plurality of link items of the integrated link information.

12. The recording medium according to claim 7,
wherein in the step (b), link destination information indicating a link destination of each link item in the integrated link information is generated, using storage destination folder information of the electronic document of the link destination.

13. An electronic document managing apparatus comprising:
a reading unit that reads a plurality of electronic documents with integrated link information added thereto, the integrated link information being generated by integrating link information relating to internal link destinations of the respective electronic documents; and
a display control unit that displays the integrated link information in respective link display fields of the plurality of electronic documents,
wherein the plurality of electronic documents include a first electronic document and a second electronic document,
in response to selection operation of the link item that is displayed in the link display field in the first electronic document and relates to a specific reference destination in the second electronic document, the display control unit displays a page including the specific reference destination of the second electronic document, in a body text display field of the second electronic document, and
in response to the selection operation, the display control unit displays, in the link display field of the second electronic document, the link item associated with a page displayed in a body text display field of the first electronic document immediately before the selection operation.

14. A non-transitory computer-readable recording medium storing a computer program for performing the steps of:
(a) reading a first electronic document from a plurality of electronic documents with integrated link information added thereto, the integrated link information being generated by integrating link information relating to internal link destinations of the respective electronic documents;
(b) displaying a plurality of link items of the integrated link information in a link display field of the first electronic document;
(c) displaying, in a body text display field of a second electronic document among the plurality of electronic documents, a page including a specific reference destination of the second electronic document, in response to selection operation of the link item that is displayed in the link display field in the first electronic document and relates to the specific reference destination in the second electronic document; and
(d) in response to the selection operation, displaying, in a link display field of the second electronic document, the link item associated with a page displayed in a body text display field of the first electronic document immediately before the selection operation.
